(19) United States
(12) Patent Application Publication
(10) Pub. No.: US 2023/0349734 A1
(43) Pub. Date: Nov. 2, 2023

(54) TRANSDUCER STRUCTURE AND METHOD OF ADHERING A TRANSDUCER TO A TRANSDUCER STRUCTURE

(71) Applicant: Forcen Inc., Toronto (CA)

(72) Inventors: Samuel Joonsik Kim, Toronto (CA); I-Hsiang Chen, Toronto (CA); Robert Joseph Brooks, Mississauga (CA)

(21) Appl. No.: 18/134,329

(22) Filed: Apr. 13, 2023

Related U.S. Application Data
(60) Provisional application No. 63/336,521, filed on Apr. 29, 2022.

(51) Int. Cl. G01D 11/30

(52) U.S. Cl. CPC G01D 11/30

(57) ABSTRACT

There is provided a transducer structure having at least one mechanical restraint. The at least one mechanical restraint is shaped to receive a transducer such that the at least one mechanical restraint at least partially limits the positioning of the transducer on the transducer structure. The at least one mechanical restraint pins at least a portion of the transducer in at least two degrees of freedom when the transducer is positioned on the transducer structure.

### CROSS-REFERENCE TO RELATED APPLICATION

This application claims priority from U.S. provisional patent application No. 63/336,521 filed on Apr. 29, 2022, which is incorporated herein by reference in its entirety.

### FIELD OF THE INVENTION

The present invention is directed to the field of transducers. More particularly, the present invention provides a transducer structure for receiving a transducer and a method of adhering a transducer to a transducer structure.

### INTRODUCTION

Transducers may be used to measure a wide range of positional data of a body when adhered to the body. The transducer may measure one or more of temperature, applications of forces, positions, deformations, and/or derivatives thereof. The accuracy of the transducer measurement depends on how the transducer is applied to the body. Often, the transducer is calibrated after the transducer is positioned on the body. Calibration adjustments are used to improve the accuracy of the measured data by compensating for errors introduced from improper placement of the transducer and/or machining errors. Calibration can be time consuming and expensive. Calibrating a plurality of bodies and transducers can be even more time consuming and expensive since the machining and positional errors may vary between each body. The difficulty associated with calibrating transducers may be exacerbated with increasing number of degrees of freedom measured by the transducer.

Reference geometries, such as but not limited to fiducials and locating pins, have been used to facilitate the accurate and repeatable placement of transducers. However, while these reference geometries may be applicable on a larger scale, they can break down when dealing with smaller bodies that require finely-tuned measurements. Reference geometries also have their own positional and machining errors that can exacerbate errors in transducer readings, requiring additional calibration based on each particular transducer and body.

### SUMMARY OF THE INVENTION

In accordance with one aspect of this disclosure, there is provided a transducer structure comprising:
at least one mechanical restraint, the at least one mechanical restraint being shaped to receive a transducer such that the at least one mechanical restraint at least partially limits the positioning of the transducer on the transducer structure,
wherein the at least one mechanical restraint pins at least a portion of the transducer in at least two degrees of freedom when the transducer is positioned on the transducer structure.

In any embodiment, the at least one mechanical restraint may pin the transducer in at least three degrees of freedom.

In any embodiment, the at least one mechanical restraint may pin the transducer proximate a stress concentration zone of the transducer structure.

In any embodiment, the at least one mechanical restraint may include an elongated member.

In any embodiment, the transducer may have a plurality of zones and the at least one mechanical restraint may pin the transducer in the at least two degrees of freedom across the plurality of zones.

In any embodiment, the at least one mechanical restraint may include at least one corner that restrains the transducer in a cartesian plane and a rotational plane.

In any embodiment, the at least one mechanical restraint may include a groove having a plurality of walls extending from a base and the groove has a groove height extending from the base to a top of each wall in the plurality of walls.

In any embodiment, the groove height may be greater than a thickness of the transducer.

In any embodiment, the groove height may be variable.

In any embodiment, the at least one mechanical restraint may be positioned on a first surface and the transducer may extend parallel the first surface when positioned on the transducer structure.

In any embodiment, the at least one mechanical restraint may pin the transducer in a plurality of degrees of freedom along the first surface when the transducer is positioned on the transducer structure.

In any embodiment, the at least one mechanical restraint may include a plurality of mechanical restraints, the transducer structure may include a plurality of surfaces, and wherein the plurality of mechanical restraints may pin the transducer in the at least two degrees of freedom across each surface in the plurality of surfaces.

In any embodiment, the at least one mechanical restraint may have at least one channel for controlling the displacement of adhesive when the transducer is adhered to the transducer structure.

In any embodiment, the at least one channel may extend along a plurality of surfaces.

In any embodiment, the transducer structure may further comprise a strain controller for controlling the sensitivity of the transducer when the transducer is positioned on the transducer structure.

In any embodiment, the strain controller may be at least one kerf in the transducer structure that forms an elongate member on which the transducer is positionable.

In any embodiment, the transducer structure may be a monolithic structure.

In any embodiment, the at least one mechanical restraint may be matingly shaped to receive the transducer such that the shape of the at least one mechanical restraint may substantially limit the positioning of the transducer on the transducer structure.

In any embodiment, the at least one mechanical restraint may surround at least a portion of a perimeter of the transducer when the transducer is positioned on the transducer structure.

In any embodiment, the transducer may be flexible such that the transducer is conformable to a curved surface.

In any embodiment, the transducer may be substantially incompressible and inextensible.

In any embodiment, the at least one mechanical restraint may be removable.

In accordance with another aspect of this disclosure, there is provided a method of adhering a transducer to a transducer structure, the transducer structure having at least one mechanical restraint, the method comprising:
applying an adhesive to a region of the transducer structure; and
positioning a portion of the transducer in the region such that the at least one mechanical restraint pins at least a portion of the transducer in at least two degrees of freedom.

In any embodiment, the region may be a first region and the portion may be a first portion, the method may further comprise:
applying the adhesive to a second region of the transducer structure; and
positioning a second portion of the transducer in the second region such that the at least one mechanical restraint pins at least a portion of the transducer from moving in at least two degrees of freedom.

In any embodiment, the method may further comprise:
applying the adhesive to a third region of the transducer structure; and
positioning a third portion of the transducer in the third region such that the at least one mechanical restraint pins at least a portion of the transducer in at least two degrees of freedom.

In any embodiment, the method may further comprise applying a clamping force to the portion of the transducer in the region.

In any embodiment, the at least one mechanical restraint may comprise a plurality of mechanical restraints.

In any embodiment, the at least one mechanical restraint may be removable and the method may further comprise removing the at least one mechanical restraint from the transducer structure.

In any embodiment, the at least one mechanical restraint may include an elongated member.

In any embodiment, the method may further comprise:
applying a clamping force to the portion of the transducer in the region; and
machining at least one strain controller into the transducer structure.

In any embodiment, the clamping force may be applied until the adhesive is at least partially cured and machining the at least one strain controller may occur after the adhesive has at least partially cured.

These and other aspects and features of various embodiments will be described in greater detail below.

### BRIEF DESCRIPTION OF THE DRAWINGS

For a better understanding of the described embodiments and to show more clearly how they may be carried into effect, reference will now be made, by way of example, to the accompanying drawings in which:

FIG. 1 is a top perspective view of a transducer structure with a transducer positioned thereon;

FIG. 2 is a front perspective view of the transducer structure of FIG. 1;

FIG. 3 is a bottom perspective view of the transducer structure of FIG. 1;

FIG. 4 is a front perspective view of the transducer structure of FIG. 1;

FIG. 5A is a top perspective view of the transducer structure of FIG. 1;

FIG. 5B is a top view of the transducer structure of FIG. 1 without the transducer;

FIG. 6A is a side view of the transducer structure of FIG. 1 without the transducer;

FIG. 6B is a bottom view of the transducer structure of FIG. 1 without the transducer;

FIG. 7A is a front perspective view of the transducer structure of FIG. 1;

FIG. 7B is a front perspective view of the transducer structure of FIG. 1;

FIG. 8A is a top view of the transducer structure of FIG. 1 without the transducer;

FIG. 8B is a top view of the transducer structure of FIG. 1 without the transducer;

FIG. 9A is a cross-sectional perspective view of the transducer structure of FIG. 1, taken along the line A-A in FIG. 2;

FIG. 9B is a cross-sectional perspective view of the transducer structure of FIG. 1, taken along the line B-B in FIG. 2;

FIG. 9C is a cross-sectional perspective view of the transducer structure of FIG. 1, taken along the line C-C in FIG. 2;

FIGS. 10A-10D illustrate a progressive registration method of securing a transducer to a transducer structure;

FIGS. 11A-11C illustrate various relief channels for a transducer structure;

FIG. 12 is a top perspective view of another transducer structure and transducer;

FIG. 13 is a top perspective view the transducer structure of FIG. 12;

FIG. 14 is a top perspective view of the transducer structure of FIG. 12 without the transducer.

FIG. 15 is a top view of the transducer structure of FIG. 12;

FIG. 16 is a perspective view of a portion of the transducer structure FIG. 12;

FIG. 17 is a cross-sectional perspective view of the transducer structure of FIG. 12, taken along the line D-D in FIG. 15;

FIG. 18 is a top perspective view of the transducer structure of FIG. 17;

FIG. 19 is a bottom perspective view of the transducer structure of FIG. 17;

FIG. 20 is a flow chart of a method of adhering a transducer to a transducer structure;

FIGS. 21A, 21C, and 21E are top views of a transducer structure in various stages of machining.

FIGS. 21B, 21D, and 21F are cross-sectional views of the transducer structure of FIG. 21A, taken along the line E-E in FIG. 21A;

FIG. 22A is a top view of another transducer structure;

FIG. 22B is a cross-sectional view of the transducer structure of FIG. 22A;

FIG. 22C is a top view of another transducer structure;

FIG. 22D is a cross-sectional view of the transducer structure of FIG. 22D;

FIG. 23A is a front perspective view of another transducer structure with a transducer having an alignment mark; and

FIG. 23B is a front perspective view of the transducer structure of FIG. 23A after machining.

The drawings included herewith are for illustrating various examples of articles, methods, and apparatuses of the teaching of the present specification and are not intended to limit the scope of what is taught in any way.

### DESCRIPTION OF EXAMPLE EMBODIMENTS

Various apparatuses, methods and compositions are described below to provide an example of an embodiment of each claimed invention. No embodiment described below limits any claimed invention and any claimed invention may cover apparatuses and methods that differ from those described below. The claimed inventions are not limited to apparatuses, methods and compositions having all of the features of any one apparatus, method or composition described below or to features common to multiple or all of the apparatuses, methods or compositions described below. It is possible that an apparatus, method or composition described below is not an embodiment of any claimed invention. Any invention disclosed in an apparatus, method or composition described below that is not claimed in this document may be the subject matter of another protective instrument, for example, a continuing patent application, and the applicant(s), inventor(s) and/or owner(s) do not intend to abandon, disclaim, or dedicate to the public any such invention by its disclosure in this document.

The terms “an embodiment,” “embodiment,” “embodiments,” “the embodiment,” “the embodiments,” “one or more embodiments,” “some embodiments,” and “one embodiment” mean “one or more (but not all) embodiments of the present invention(s),” unless expressly specified otherwise.

The terms “including,” “comprising” and variations thereof mean “including but not limited to,” unless expressly specified otherwise. A listing of items does not imply that any or all of the items are mutually exclusive, unless expressly specified otherwise. The terms “a,” “an” and “the” mean “one or more,” unless expressly specified otherwise.

As used herein and in the claims, two or more parts are said to be “coupled”, “connected”, “attached”, or “fastened” where the parts are joined or operate together either directly or indirectly (i.e., through one or more intermediate parts), so long as a link occurs. As used herein and in the claims, two or more parts are said to be “directly coupled”, “directly connected”, “directly attached”, or “directly fastened” where the parts are connected in physical contact with each other. None of the terms “coupled”, “connected”, “attached”, and “fastened” distinguish the manner in which two or more parts are joined together.

Furthermore, it will be appreciated that for simplicity and clarity of illustration, where considered appropriate, reference numerals may be repeated among the figures to indicate corresponding or analogous elements. In addition, numerous specific details are set forth in order to provide a thorough understanding of the example embodiments described herein. However, it will be understood by those of ordinary skill in the art that the example embodiments described herein may be practiced without these specific details. In other instances, well-known methods, procedures, and components have not been described in detail so as not to obscure the example embodiments described herein. Also, the description is not to be considered as limiting the scope of the example embodiments described herein.

As used herein, the wording “and/or” is intended to represent an inclusive-or. That is, “X and/or Y” is intended to mean X or Y or both, for example. As a further example, “X, Y, and/or Z” is intended to mean X or Y or Z or any combination thereof.

As used herein and in the claims, two elements are said to be “parallel” where those elements are parallel and spaced apart, or where those elements are collinear.

### General Description of a Transducer Structure

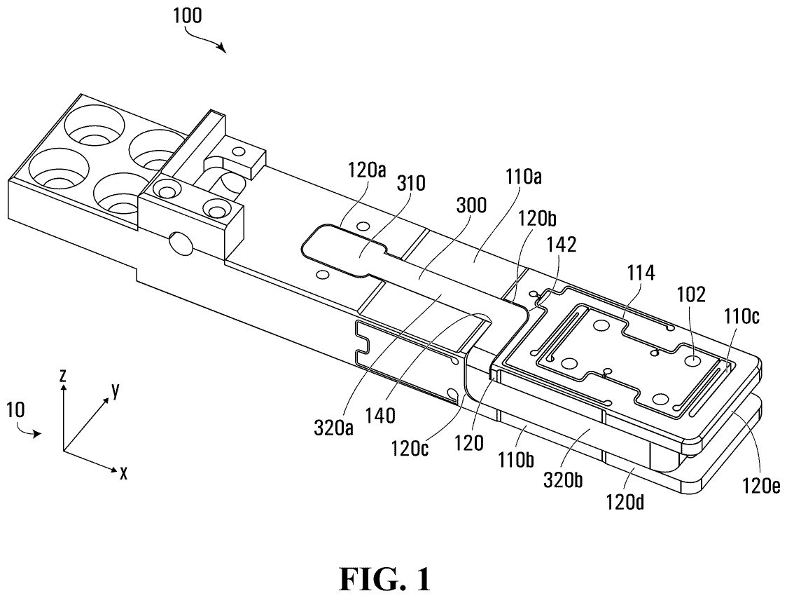

Referring to FIG. 1, shown therein is an exemplary embodiment of a transducer structure 100 with a transducer 300. The transducer 300 is positioned on the transducer structure 100 such that the transducer 300 can measure one or more types of data based on changes to the transducer structure 100. For example, the transducer 300 may include, but is not limited to, force sensors, strain gauges, piezoelectric sensors, capacitive force sensors, optical force sensors, fiber optic force sensors, Bragg's diffraction gratings, silicone strain gauges, metal foil strain gauges, and/or combinations thererof.

In some embodiments, the transducer 300 may have a plurality of strain gauges (not shown). Each strain gauge may be positioned on a surface to be measured 110. During use, when the transducer structure 100 experiences an applied force, deformation of the transducer structure 100 results in deformation of one or more of the surfaces to be measured 110, introducing strain to the surface to be measured 110. Strain is the ratio of measured length to the original length in a particular direction. The strain gauges operate to measure the relative change to the surface to be measured 110, such that the deformation can be calculated. For example, if the surface to be measured 110 is compressed, the strain value will be less than 1. Conversely, if the surface to be measured 110 is elongated, the strain value will be greater than 1.

Measuring the strain of a surface to be measured 110 caused by the application of force to the transducer structure 100 allows a user to calculate the value of the applied force that caused the deformation of the surface to be measured 110. This calculation may be determined by using known material properties of the transducer structure 100 and the known geometry of the transducer structure 100. Thus, by measuring strain using a strain gauge, the applied force can be determined.

Strain is most easily measured along an axis, or, in other words, within a particular degree of freedom (DoF). For example, strain can be measured in a first direction, a second direction, and a third direction, with each of the first, second, and third directions being perpendicular to one another in a Cartesian coordinate system. These directions are typically referred to as x, y, and z directions. An example coordinate system 10 is shown in FIG. 1. Each of the three directions has a translational component, movement along the direction, and a rotational component, rotating about the axis of the direction. The translational and rotational components result in six DoF in a Cartesian coordinate system. Accordingly, an applied force can have six components: Fx, Fy, Fz, Mx, My, and Mz, where F=force and M=moment.

The applied force may not be unidirectionally applied to the transducer structure 100. The force may be applied at an angle to the first, second, and/or third directions of the structure 100, thereby applying a resultant force that can be separated into axial forces applied along each direction and rotational forces causing a moment about each axis. Accordingly, to measure an accurate applied force, the force along each axis can be calculated from measured strain values for each surface to be measured 110.

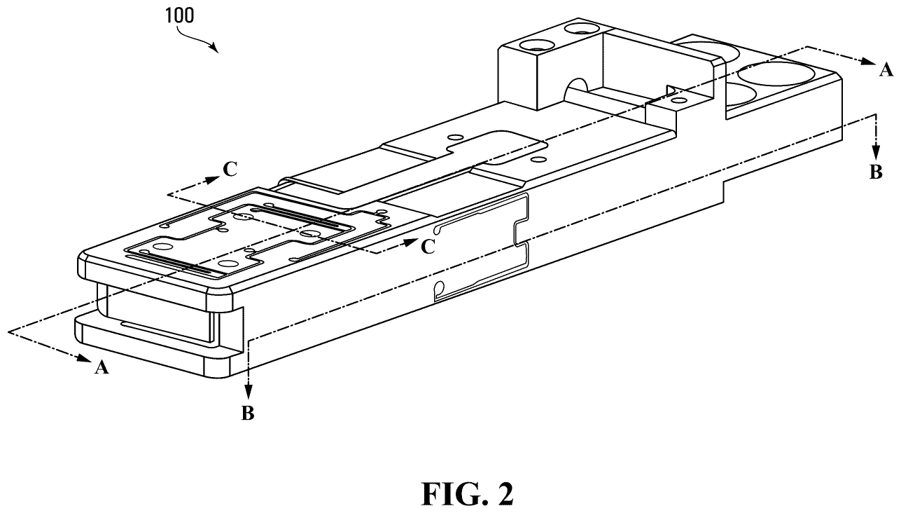

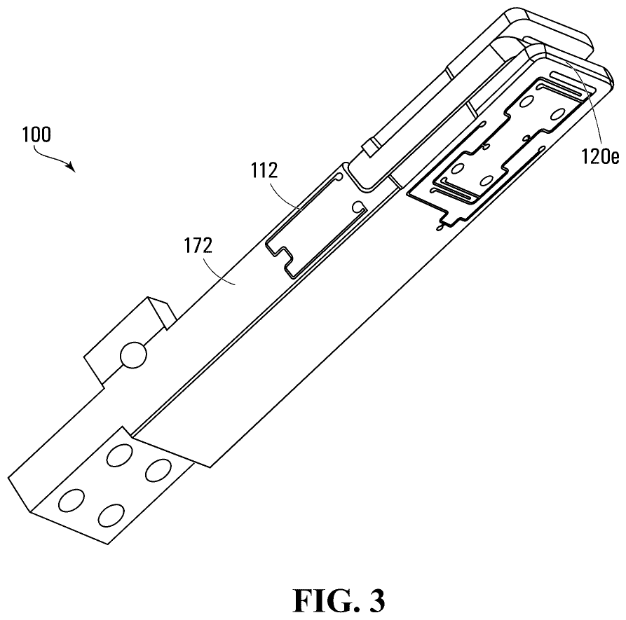

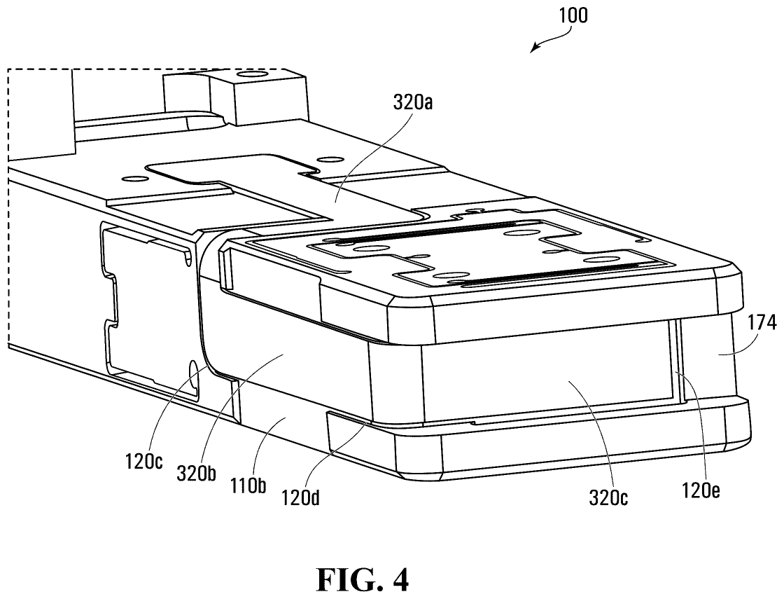

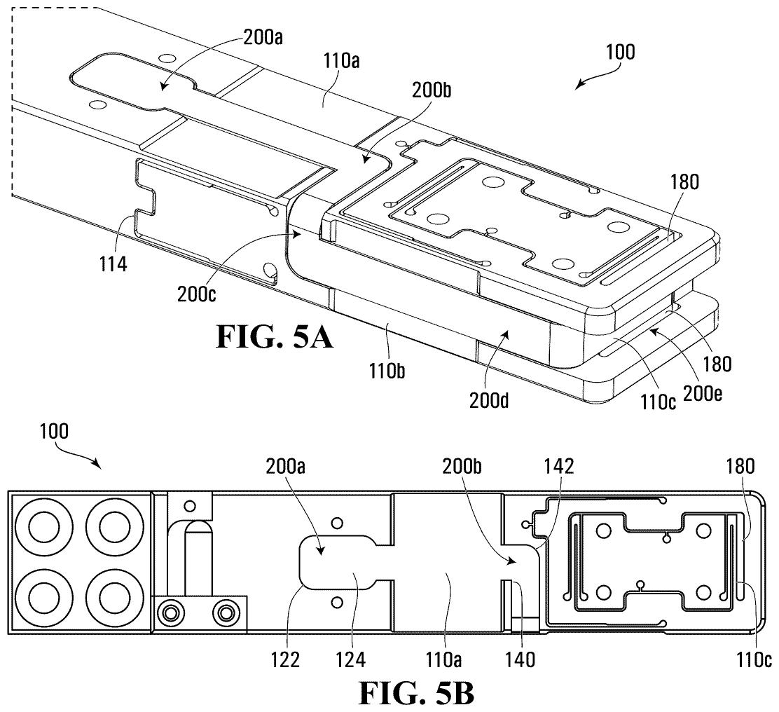

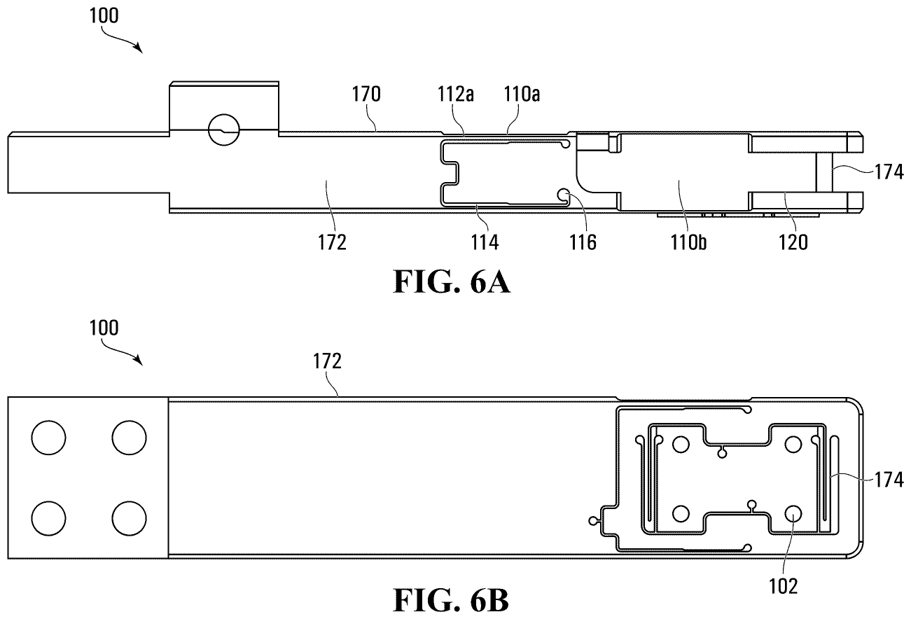

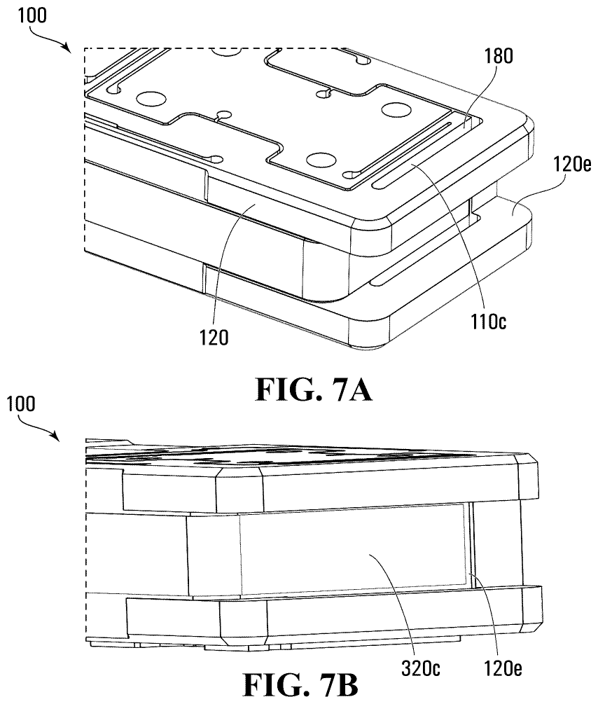

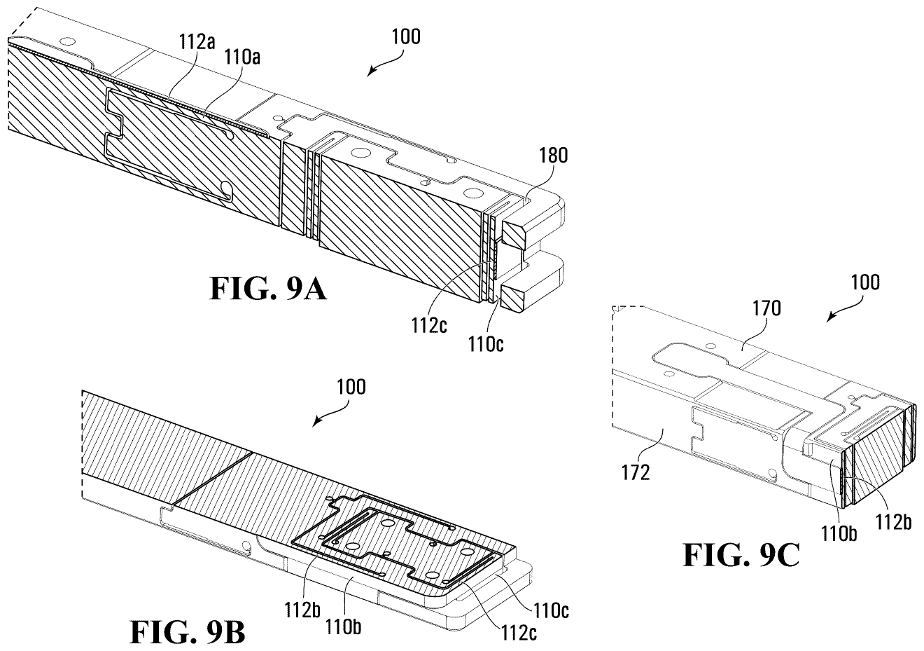

The surface to be measured 110 may be an elongate member shaped to receive the transducer 300. For example, the surface to be measured 110 may be a thin beam. To measure force and/or torque, the transducer may be secured to an elongated beam 112 to measure its relative deflection as a result of the net force/torque on the transducer structure 100. For example, the transducer 300 may have a plurality of strain gauge sensors and a plurality of elongate beams 112, with each one or more sensors positioned on its respective elongate beam 112, as exemplified in FIGS. 1-10D.

The transducer 300 may include one or more temperature sensors. The inclusion of a temperature sensor may allow for local compensation of individual transducers. In other words, the temperature sensor may be used in combination with the deformation sensors to account for temperature changes and gradients, thereby improving the accuracy of the output data from the transducer 300.

Referring to FIG. 1, as shown, the transducer 300 may be a thin film transducer. As exemplified, the transducer 300 can range from about 25 to about 150 microns in thickness. It will be appreciated that the transducer 300 may have a thickness in the range of about 500 nanometer to about 500 microns.

The applied force may come from any application, such as a transducer structure 100 coupled to an end effector for interacting with one or more objects that introduce deformation to the transducer structure 100. For example, the transducer structure 100 shown in FIG. 1 is a finger that may be used to interact with objects and measure the applied forces as a result of that interaction. As shown, the transducer structure 100 has a plurality of couplings 102 for attaching additional end effectors.

### Limiting the Positioning of a Transducer on the Transducer Structure

The accuracy of positioning the transducer 300 on the transducer structure 100 in a desired location may have a large impact on the accuracy of the data measured by the transducer 100, particularly if the transducer structure 100 is of relatively small scale. For small scale applications, if the transducer 300 is even a few millimeters off, the measured data may be inaccurate and/or less sensitive, perhaps even to the point that the data is unusable. To account for positional error, the transducer 300 may be calibrated by various adjustments after the transducer 300 has been secured to the transducer structure 100. However, such calibration can be very time consuming and expensive and cannot address a loss in sensitivity. While large scale applications can still have increased error from misplacement of the transducer 300 on the surface to be measured 110, a few millimeters will often not form consequential errors in the data due to the relative size of the surface to be measured 110 to the overall transducer structure 100. That being said, the positioning of the transducer 300 on the surface to be measured 110 should be as accurate as possible to reduce or eliminate calibration costs once the transducer 300 has been secured to the surface to be measured 110.

In accordance with one or more embodiments herein, there is provided a transducer structure 100 that has at least one mechanical restraint 120, as exemplified in FIG. 1. The at least one mechanical restraint 120 at least partially limits the positioning of a transducer 300 on the transducer structure 100. The at least one mechanical restraint 120 also operates to pin at least a portion of the transducer 200 in at least two DoF when the transducer 300 is positioned on the transducer structure 100. In other words, the at least one mechanical restraint 120 may mechanically hold the transducer 300 in position such that the transducer 300 is restricted from movement in at least two DoF. As used herein, to pin refers to substantially prevent from moving. By using the at least one mechanical restraint 120 to pin the transducer 300 in at least two DoF, the transducer 300 is substantially prevented from moving in those two DoF.

The design of the transducer structure 100 having at least one mechanical restraint 120 allows for improved and/or optimized accuracy when positioning of the transducer 300 on the surface to be measured 110. By optimizing the positional accuracy of the placement of the transducer 300, subsequent calibration adjustments may be minimized or eliminated. In other words, the use of the at least one mechanical restraint 120 to pin at least a portion of the transducer 300 in at least two DoF functions as a form of calibration by design. An advantage of this design is that positional errors may be reduced or eliminated, thereby reducing or eliminating the need for post-application calibration adjustments, saving time and money.

Additionally, by designing the transducer structure 100 to limit the positioning of the transducer 300, the design may be used to repeatedly manufacture a plurality of transducer structures 100 having almost identical calibration by design features. Accordingly, the positional accuracy of the transducer 300 on the transducer structure 100 may be repeatably improved across the entire manufacturing process of a plurality of transducer structures 100, reducing and/or eliminating the need for calibration adjustments.

It will be appreciated that errors, such as machining errors and accidental positional changes caused by clamping a body to a surface having an adhesive, may result in minor positional inaccuracies of the transducer 300. In such situations, calibration adjustments may be used to adjust for these errors.

A difficulty with measuring an applied force is that the force applied in a single direction may result in strain output measurement in a plurality of directions across different sensors. This phenomenon is known as crosstalk. For example, a strain gauge that is meant to measure strain in the x direction may be interfered with by applied force in the y direction, causing an error in the measurement of the x direction strain gauge, which has picked up strain from the applied force. This error may be introduced, for example, by imprecise application of the strain gauge to the transducer structure 100 or by machining tolerance errors. The transducer structure 100 may be designed in such a way as to reduce the amount of crosstalk. For example, referring to FIG. 1, the transducer structure 100 has a plurality of elongate beams 112 that are designed to facilitate the transmission of force across strain gauges in each of the x, y, and z directions to reduce the likelihood of crosstalk between two or more directions.

The at least one mechanical restraint 120 may be any mechanical feature that operates to restrict the positioning of the transducer 300 on the transducer structure 100 and, when positioned on the transducer structure 100, pins at least a portion of the transducer 300 in at least two degrees of freedom. For example, the at least one mechanical restraint 120 may be, but is not limited to, an elongated member, a groove, a cavity, a mold, a solder-paste surface tension adhesion lock.

The mechanical restraint 120 may be a single mechanical restraint or may be a plurality of mechanical restraints. As exemplified in FIG. 1, the transducer structure 100 has a plurality of mechanical restraints 120. Each mechanical restraint 120 may operate to limit the positioning of the transducer 300 on the transducer structure 100 and, when positioned on the structure, pin at least a portion of the transducer 300 in at least two DoF.

The plurality of mechanical restraints 120 may be connected to one another, such as a groove, or may be separated from one another, such as a groove and an elongated member. As shown in FIG. 1, the at least one mechanical restraint 120 is a plurality of mechanical restraints 120a, 120b, 120c, 120d, 120e. Each mechanical restraint 120 operates to limit the positioning of the transducer 300 on the transducer structure 100 and pins at least a portion of the transducer 300 in at least two DoF. Thus, the mechanical restraint 120 limits where the transducer 300 can be positioned on the structure 100 while also limiting the moveability of the transducer 300 once positioned on the structure 100.

The at least one mechanical restraint 120 may limit the positioning of the transducer 300 on the transducer structure 100 such that the strain sensor is positioned within a certain tolerance of error from the desired position. The desired position may vary depending on the desired application of the transducer structure 100. For example, in some embodiments, properly positioning the transducer 300 means that the strain sensor is positioned within 50 microns of the desired position. In some embodiments, the tolerance for error may be in, including, but not limited to, the range of about 1 micron to about 0.5 millimeters.

In some embodiments, the at least one mechanical restraint 120 may pin at least a portion of the transducer 300 in at least three DoF. For example, as shown in FIG. 1, the at least one mechanical restraint 120a is a groove on the surface of the transducer structure 100. The groove 120a has a plurality of walls 122 extending from a base 124 and has a groove height that extends from the base 124 to a top of each wall in the plurality of walls 122. The groove 120a forms a key shape in the transducer structure 100 that receives a key portion 310 of the transducer 300. Thus, the key portion 310 may fit within the groove 120a on the transducer structure 100, such that the positioning of the transducer 300 is limited by the groove 120a. Additionally, once positioned in the groove 120a, the key portion 310 of the transducer 300 is pinned by the groove 120a in a way that prevents movement of the transducer 300 from moving in three DoF. As shown, the key portion 310 of the transducer 300 is pinned in the translational x and y DoF and in the rotational z DoF. In other words, when the key portion 310 of the transducer 300 is positioned within the groove 120a of the transducer structure 100, the key portion 310 of the transducer 300 cannot translate in the xy plane, nor can it rotate about the z-axis. Thus, the transducer 300 is pinned in at least three DoF.

The at least one mechanical restraint 120 may be shaped in any way that limits the positioning of the transducer 300 and pins it in at least two DoF. As described above, the groove 120a may be key-shaped for receiving the key portion 310 of the transducer 300. As exemplified in FIG. 1, the mechanical restraint 120 may be a groove 120b forming a corner that pins the transducer 300 in three DoF. As shown, the groove 120b has a first portion 140 and a second portion 142 spaced apart from the first portion 140. The transducer 300 is correspondingly shaped such that the groove 120b can receive the transducer 300 between the first portion 140 and the second portion 142. As shown, the first portion 140 pins the transducer 300 from moving in the negative x and negative y directions and the second portion 142 pins the transducer 300 from moving in the positive x and positive y directions. Additionally, due to the separation of the first portion 140 and the second portion 142, the two portions prevent the transducer 300 from rotation about the z-axis. Thus, the transducer 300 is pinned in three DoF.

The at least one mechanical restraint 120 may operate to protect the transducer 300 from damage by surrounding at least a portion of a perimeter of the transducer 300 when the transducer 300 is positioned on the transducer structure 100. By surrounding at least a portion of the perimeter of the transducer, the groove 120 may operate as a buffer to protect the transducer 300 from damage. For example, the key shaped portion of the groove 120 protects the key portion 310 of the transducer 300 from delamination and contact damage.

It will be appreciated that the groove height may be any size depending on the desired use of the transducer structure 100. For example, referring to FIG. 1, the mechanical restraint 120e proximate the front end of the transducer structure 100 is a groove 120e that has a larger groove height than other mechanical restraints 120 on the transducer structure 100. This larger groove height may prevent contact damage to the transducer 300 from the transducer structure 100 coming into contact with a surface, intentionally or accidentally. Additionally, the groove may prevent delamination of the transducer 300 from the transducer structure 100.

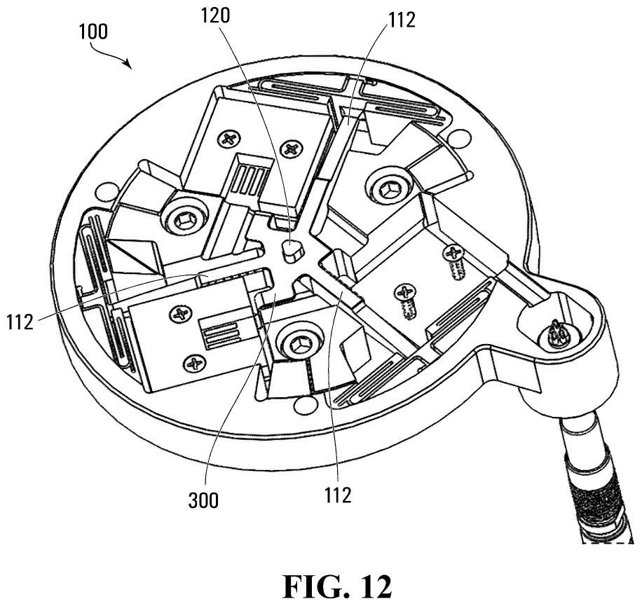

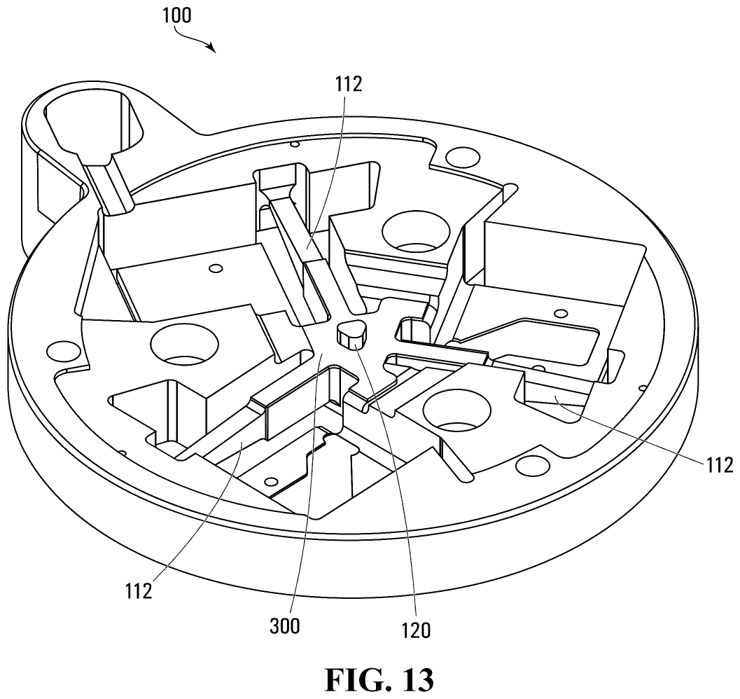

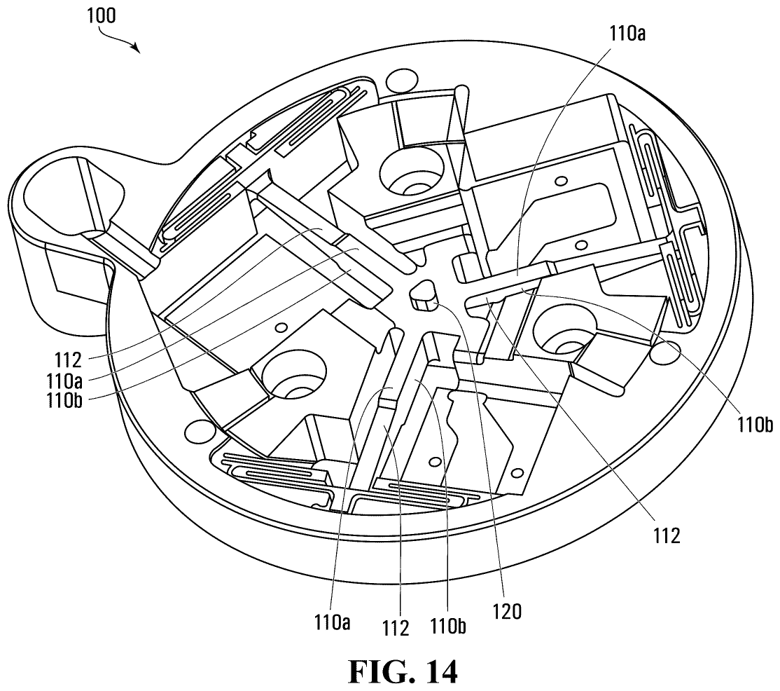

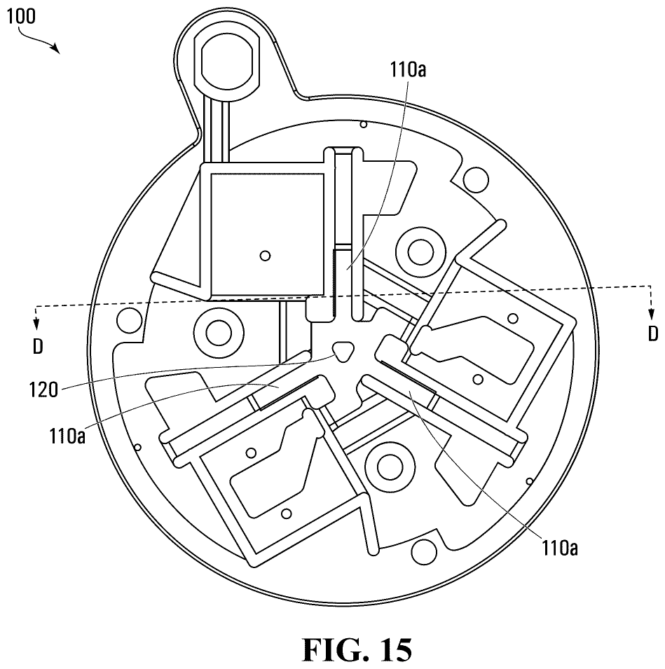

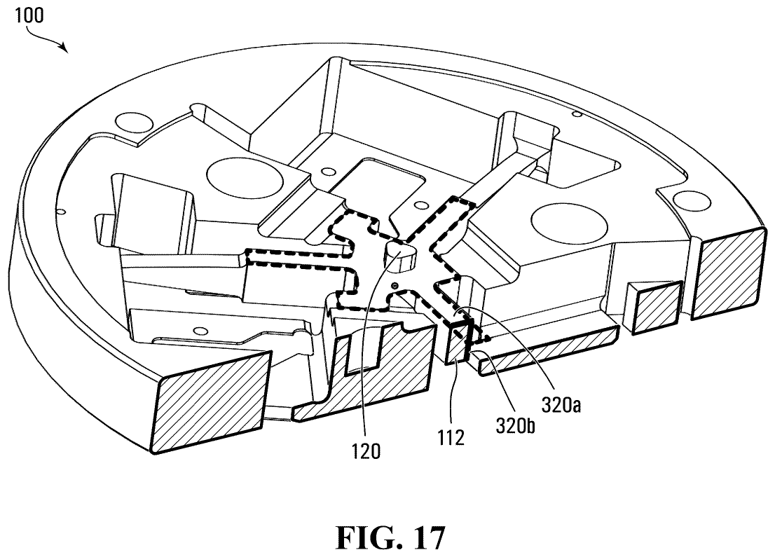

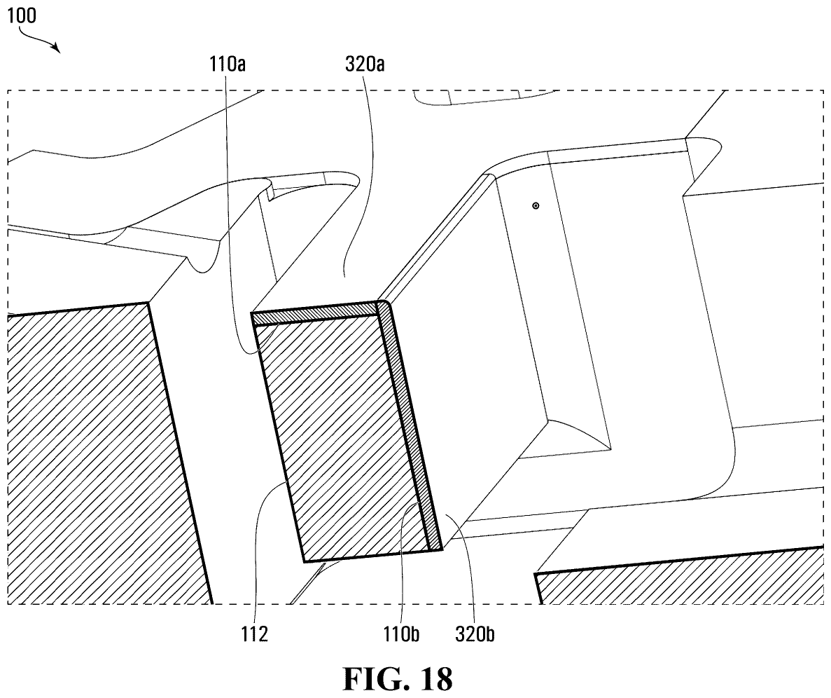

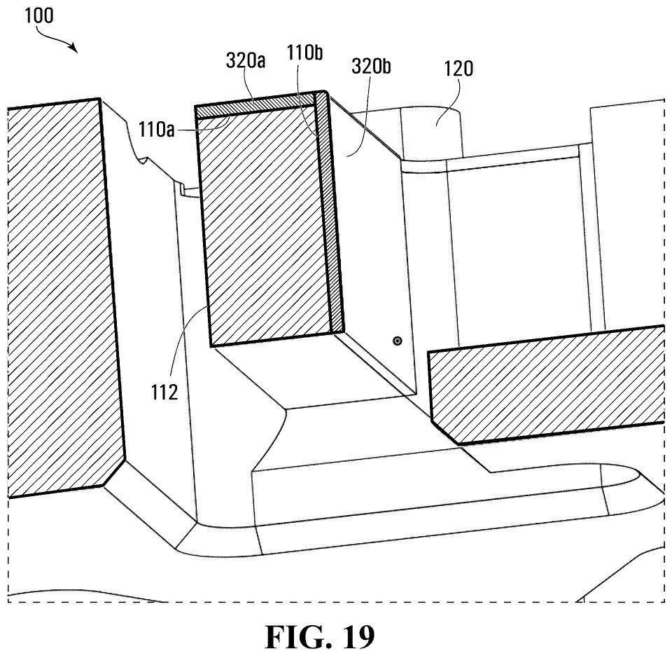

As exemplified in FIGS. 12-19, the at least one mechanical restraint 120 is an elongated member 120. The elongated member 120 has a generally triangular cross-sectional shape. Accordingly, the triangularly shaped elongated member 120 may operate to pin at least a portion of the transducer 300 in three degrees of freedom: translationally in the xy plane and rotationally about the z-axis. The transducer 300 has an aperture 350 that is shaped to receive the elongate member 120. In other words, as exemplified in FIGS. 12-19, the aperture 350 is generally triangularly shaped. The mechanical restraint 120 operates to pin a portion of the transducer 300 in three DoF, while also limiting the positioning of the rest of the transducer 300 along the transducer structure 100. The aperture 350 may be any size and/or shape that can receive the elongate member 120 such that the at least a portion of the transducer 300 is pinned in at least two DoF.

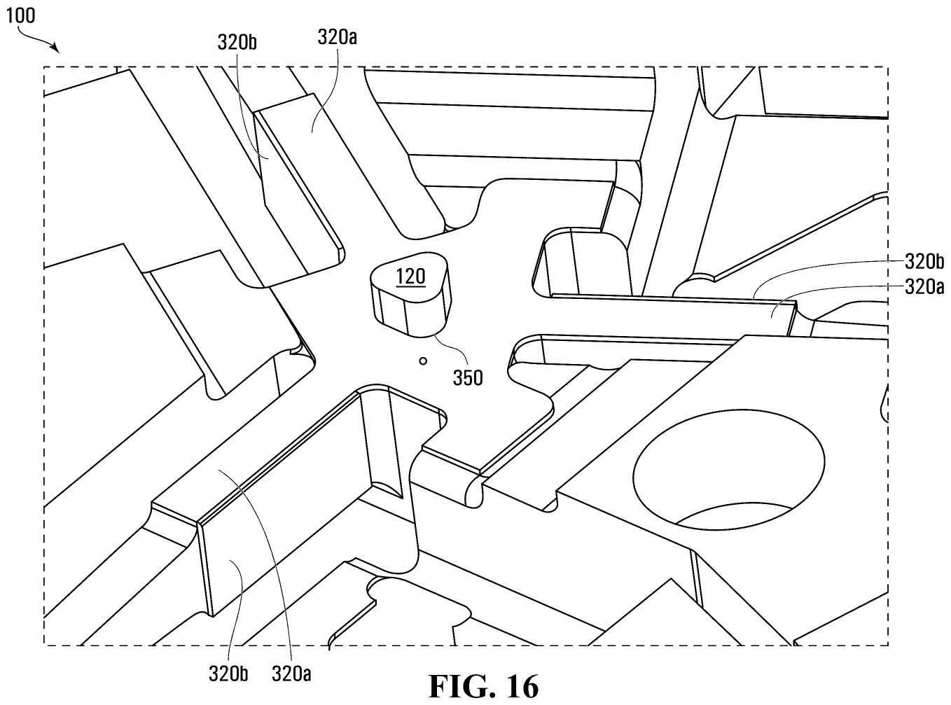

As exemplified in FIGS. 12-19, the transducer structure 100 includes three elongate beams 112 each having two surfaces to be measured 110. The surfaces to be measured 110 are generally perpendicular to each other along each elongate beam 112. Each surface to be measured 110 is for receiving a sensing portion 320 of the transducer 300. For example, as shown in FIG. 16, each elongate beam 112 has a first surface to be measured 110a and a second surface to be measured 110b. Each surface to be measured 110a and 110b receives a corresponding sensing portion 320a and 320b, respectively, of the transducer 300. Accordingly, there are six sensing portions 320, which allows for the measurement of data in six DoF (Fxyz and Mxyz).

In some embodiments, the at least one mechanical restraint 120 may include a plurality of mechanical restraints 120 of varying types, shapes, and/or sizes. For example, referring to FIG. 1, as shown, the first mechanical restraint 120 is a key-shaped groove 120a for receiving the key portion 310 of the transducer 300 and the second mechanical restraint 120b is a groove forming a corner. In some embodiments, the transducer structure 100 may include a triangularly-shaped elongated member 120 and a groove 120.

### Response and Sensor Locations

Proper positioning of the transducer 300 on the transducer structure 100 may vary depending on the use of the transducer structure. As described previously, the transducer 300 may have at least one strain sensor. To improve the accuracy of the strain measurement, the strain sensor may be positioned proximate a stress concentration zone on the transducer structure. The size, shape, and/or number of stress concentration zones may be designed to maximize the dynamic range of the transducer 300 and/or minimize noise in the output signal. For example, as shown in FIGS. 1-10D, the transducer structure 100 has three stress concentration zones 112. Each stress concentration zone is an elongate beam 112 that forms the surface to be measured 110 for receiving a strain sensor. Accordingly, the at least one mechanical restraint 120 may pin at least a portion of the transducer 300 in at least two DoF such that each sensor in the transducer 300 is positioned proximate its respective stress concentration zone on its respective elongate beam 112.

The at least one mechanical restraint 120 may operate to limit the positioning of the transducer 300 such that the mechanical restraint 120 does not interfere with the surface to be measured 110. In other words, the pinning of the transducer 300 may occur at a location that is spaced apart from the surface to be measured 110, while restricting the positioning on the transducer 300 such that the strain sensor is properly positioned on the surface to be measured 110. For example, as shown in FIG. 1, the at least one mechanical restraint 120a is a groove that restricts the positioning of the transducer 300 in three DoF without extending onto the surface to be measured 110a, which is positioned adjacent the groove 120a. Accordingly, the groove limits the positioning of the transducer 300 on the transducer structure 100 such that the strain sensor is optimally positioned on the elongate beam 112a without compromising the structure of the elongate beam 112a. An advantage of this design is that the separation of the at least one mechanical restraint 120 from the surface to be measured 110 reduces and/or prevents the creation of local stress points on the surface to be measured 110. Over time, local stress points may exacerbate error through many cyclic loadings of the surface to be measured. For example, if a screw were to be used to hold the transducer 300 in place, the screw would introduce a local stress point that would interfere with the strain measurement of the elongate beam 112 and may reduce the lifetime of the transducer structure 100.

In some embodiments, as exemplified in FIGS. 1-10D, the transducer structure 100 may be formed of a monolithic structure. In other words, the transducer structure 100 may be formed of a single piece of material that is machined and/or shaped to facilitate the positioning of a transducer 300 on the transducer structure 100. By using a monolithic structure, the relative position between a plurality of sensors in the transducer 300 may be more easily maintained. An advantage of this design is that the sensitivity of each surface to be measured 110 on the transducer structure 100 may be more tightly controlled. For example, referring to FIG. 1, the transducer structure 100 is a monolithic structure that has been machined to receive the transducer 300. As described previously, the transducer structure 300 has three elongate beams 112. As shown, each elongate beam 112 is machined from the monolithic structure.

In some embodiments, the structure 100 may be formed of a plurality of components that are secured together to form a single structure. For example, a plurality of components could be, including, but not limited to, bolted, laser welded, and/or joined by epoxy to form the structure 100.

The structure 100 may include one or more strain controllers 114 for controlling the sensitivity of the surface to be measured 110 on the structure 100. For example, each elongate beam 112 may be formed by a series of strain controllers 114 that vary the sensitivity of the elongate beam 112. As exemplified, the strain controllers are kerfs 114 that are machined into the structure 100 to form the elongate beams 112. The use of kerfs 114 to control the sensitivity of the elongate beams 112 allows for a tunable approach to sensitivity control, since the thickness of each kerf 114 can be varied during manufacturing depending on the desired sensitivity level of the transducer 300. Sensitivity is determined by a ratio of the kerf width to the elongate beam length. Additionally, the strain controllers 114 may be used to govern the overload condition of each beam 112. The use of strain controllers 114 allows for thick beam portions of the monolithic structure to be converted into a thin beam to increase the sensitivity of the structure 100. For example, the thin beam may be in the range of, including, but not limited to, about 300 microns to about 20 mm.

Accordingly, the transducer structure 100 may be used in applications having a wide range of sensitivity. By designing a tunable approach to sensitivity control, the transducer structure 100 may be used to, for example, pick up anything from food to steel. The sensitivity control enables soft food, such as vegetables or imitation crab, to be picked up by the same transducer structure 100 as the structure 100 used to pick up a steel rod.

The one or more strain controllers 114 may be formed by any manufacturing method capable of precision cutting, including, but not limited to, wire EDM and/or laser waterjets. In some embodiments, such as when wire EDM is used, the strain controllers 114 may be formed by drilling a starter hole 116 and using one or more manufacturing methods to form the kerfs 114. The starter hole 116 may be in the range of about 0.7-1.0 mm and the thickness of the kerf 114 may be in the range of about 0.025 mm to about 0.5 mm. It will be appreciated that the size and thickness will vary with the size of the transducer structure 100. Once the starter hole 116 is drilled, the kerf 114 may be formed by, for example, wire EDM. For example, the wire EDM may be used when the thickness of the kerf 114 is in the range of about 150 microns. In some embodiments, a starter hole 116 may not be needed. For example, a laser waterjet may be used without first forming a starter hole 116. The laser waterjet may be used, for example, when the thickness of the kerf 114 is in the range of less than 150 microns.

### Complex Surfaces

In some embodiments, the transducer structure 100 may be designed to receive the transducer 300 across a plurality of zones 200 and the at least one mechanical restraint 120 may pin at least a portion of the transducer in the at least two DoF across the plurality of zones 200. For example, the transducer 300 may have a plurality of strain sensors, which allows for the determination of a known relationship between the positioning of each strain sensor on the transducer structure 100. An advantage of this design is that a single transducer 300 may be used to measure strain in a plurality of locations across a complex surface. Additionally, the known position of the sensing portions in the transducer 300 relative to each surface to be measured 110 may reduce calibration time and error.

As described above, the transducer structure 100 may have three elongate beams 112, each for receiving a strain sensor. Each elongate beam 112 includes a surface to be measured 110. As exemplified in FIG. 1, the surface to be measured 110a extends between a first zone 200a and a second zone 200b. Each zone 200 may be designed to receive a portion of the transducer 300 such that when the transducer 300 is positioned in the zone 200, the portion of the transducer 300 is pinned in at least two DoF in that zone 200. Accordingly, when all portions of the transducer 300 are positioned on the transducer structure 100, the at least one mechanical restraint 120 may operate to pin at least a portion of the transducer 300 across each zone 200 in the plurality of zones 200. In some embodiments, the at least one mechanical restraint 120 is a plurality of mechanical restraints 120 that pin the transducer 300 across each zone 200 in the plurality of zones 200. It will be appreciated that the one or more mechanical restraints 120 may be used on transducers 300 for measuring any number of DoF. For example, this design may be used for three or four DoF robotic wrists, three DoF joints generally, one to three DoF fingers, and/or more than four DoF structures.

In some embodiments, the zones 200 may be on a single surface. For example, referring to FIG. 1, a top surface 170 of the transducer structure 100 has a first zone 200a (formed by the key portion of the groove 120a) and a second zone 200b (formed by the corner 120b having the first portion 140 and the second portion 142). The two zones 200 operate to pin a first sensing portion 320a therebetween in three DoF. In other words, the first sensing portion 320a is pinned in the proper position on the first elongate beam 112a such that the transducer 300 extends parallel to the surface to be measured 110a when positioned on the transducer structure 100. Accordingly, the pinning of the transducer 300 in the zones 200a and 200b results in the first sensing portion 320a being properly positioned on the surface to be measured 110a.

In some embodiments, the zones 200 may be across a plurality of surfaces. For example, referring to FIG. 1, the transducer structure 300 has a plurality of surfaces for receiving the transducer: a top surface 170, a side surface 172, and a front surface 174. Each surface in the plurality of surfaces has a surface to be measured 110. As shown, the transducer 300 extends parallel along each surface in the plurality of surfaces. To maintain the positioning of the transducer 300 on the transducer structure 100 across the plurality of surfaces, there are a plurality of zones 200 across the surfaces, with each zone being formed by one or more mechanical restraints 120. As described above, the top surface 170 has the first zone 200a and the second zone 200b. As exemplified in FIGS. 1-7B, the side surface 172 includes a third zone 200c and a fourth zone 200d, and the front surface 174 includes a fifth zone 200e. The third zone 200c is formed by a corner groove 120c and the fourth zone 200d is formed by a groove 120d. The fifth zone 200e is formed by a groove 120e extending a substantial length of the front surface 174.

A second sensing portion 320b is pinned in three DoF on the second surface to be measured 110b such that the transducer 300 extends parallel to the side surface 172 when positioned on the transducer structure 100. A third sensing 320c portion is pinned in three DoF in position on the third surface to be measured 110c such that the transducer 300 extends parallel to the front surface 174 when positioned on the transducer structure 100. In other words, the pinning zones 200 formed by the plurality of mechanical restraints 120 operate to pin the transducer 300 across the plurality of surfaces, while positioning each strain sensor in its proper position on its respective surface to be measured. As described previously, the surface to be measured 110 exemplified in FIG. 1 are elongate beams 112.

Each mechanical restraint 120 in the plurality of mechanical restraints may operate to maintain the pinning of the transducer 300 in the three DoF. For example, as shown in FIG. 1, each of the first, second, and third sensing portions of the transducer 300 are pinned in the translational x and y plane and rotationally about the z-axis. Accordingly, the three DoF pinning is maintained across a complex surface structure having a plurality of surfaces.

The use of a plurality of mechanical restraints 120 may allow for each portion of the transducer 300 to be locally pinned on the transducer structure 100. Local pinning of the transducer 300 may reduce the likelihood of deformation and/or folding of the transducer 300 over larger distances across the transducer structure 100. In other words, the transducer 300 may be pinned by each mechanical restraint 120 in each region in such a way that facilitates the placement of the transducer 300 across the entire surface, or plurality of surfaces to be measured, while minimizing or eliminating damage to the transducer 300.

To facilitate the extension of the transducer 300 across the plurality of surfaces, the transducer 300 may be made of a flexible material. For example, as shown in FIGS. 1, 5A, and 10A-10D, the transducer 300 is flexible such that it can be wrapped around one or more contoured surfaces. In other words, the transducer 300 may be bendable. The flexibility of the transducer 300 may allow the transducer 300 to be manufactured on a single plane, while still allowing the transducer 300 to be wrapped onto a complex transducer structure 100. Manufacturing the transducer 300 on a single plane may reduce manufacturing time, costs, and/or errors. In some embodiments, the transducer 300 may be substantially incompressible and inextensible. In some embodiments, a stretchable transducer 300 may be used such that the stretching of the transducer 300 is controllable.

The use of a flexible transducer 300 may allow for the manufacturing of transducer structures 100 having complex surfaces. The shape of the transducer structure 100 may be customized depending on the desired use of the transducer structure 100. For example, referring to FIG. 1, the transducer structure 100 has a plurality of mechanical restraints 120 extending along a plurality of surfaces. The plurality of surfaces include rounded edges that allow the transducer 300 to extend from one surface to the next, while minimizing the likelihood of damage to the transducer 300.

Additionally, the use of a flexible transducer 300 may allow for the manufacturing of transducer structure 100 at a range of scales. For example, large scale applications may have stress concentrations that are more distributed, so precise alignment of the transducer 300 to the stress concentration regions may be less important than in smaller scale applications. In smaller scale applications, positioning the transducer 300 across multiple surfaces may be difficult and may require precise placement in order to properly align the transducer 300 with the stress concentration region. The use of a flexible transducer 300 may improve the precision by which the transducer 300 may be positioned on the transducer structure 300 across complex surfaces, while maintaining the desired placement of the transducer 300 relative to the smaller stress concentration regions. In other words, smaller scale applications may inherently make multi-surface transducer application more complex. Accordingly, a flexible transducer 300 may reduce error and improve the accuracy of the transducer structure 100.

As exemplified, the at least one mechanical restraint 120 may be matingly shaped to receive the transducer 300 such that the shape of the at least one mechanical restraint 120 limits the positioning of the transducer 300 on the transducer structure 100. As shown in FIG. 1, the mating shape of the groove 120 extends across the plurality of surfaces, which enables the use of a single flexible transducer 300 to extend across the plurality of surfaces. This flexible transducer 300 may be conformable to a curved surface. This flexibility reduces the likelihood of delamination of the transducer 300 from the transducer structure 100 and may make it easier to adhere the transducer 300 to the transducer structure 100. Additionally, the use of curved surfaces may minimize the formation of localized stress zones and may reduce the likelihood of concentrating stress in the transducer 300. Concentrating stress in the transducer 300 may result in failure of the transducer 300 due to, including, but not limited to, tension, bending, kinking and/or tearing.

It will be appreciated that the corresponding mating shape of the transducer 300 and the transducer structure 100 may be any shape and/or size that facilitates the positioning of the transducer 300 on the transducer structure 100. The mating shape may be formed of a plurality of mechanical restraints 100, including, but not limited to, grooves and/or elongated members.

In some embodiments, the complex surface of the transducer structure 100 may include a single mechanical restraint 120 that operates to pin a portion of the transducer 300 in three DoF. As exemplified in FIGS. 12-19, the transducer structure has three elongate beams 112 forming six surfaces to be measured 110. Based on the positional limitation of the elongate member 120, the sensing portions of the transducer 300 are limited in how they may be positioned on the transducer structure 100, thereby guiding the placement of the transducer 300 onto the transducer structure 100. Accordingly, the design of the transducer structure 100 may enable the positioning of the transducer 300 across complex surfaces, including three elongate beams 112 for sensing in six DoF.

### Bondline Thickness Control

The structure 100 may be designed to control the bondline thickness of the adhesive used to secure the transducer 300 to the transducer structure 100. Bondline thickness refers to the thickness, or height, of the adhesive on the surface of the transducer structure 100 that receives the adhesive and transducer 300. Bondline thickness control may also be referred to as vertical registration, since the bondline thickness controls the separation between the transducer structure 100 and the transducer 300, which in turn controls the relative distance between the top of the transducer 300 and the top of the transducer structure 100. Bondline thickness is an important feature to consider in the design of the transducer structure 100 since it has a direct impact on the response and durability of the transducer 300 when positioned on the transducer structure 100. For example, if the bondline thickness of the adhesive is too thin, there may be insufficient volume of adhesive to secure the transducer 300 to the transducer structure 100. If the bondline thickness of the adhesive is too thick, the adhesive may impact hysteresis and may result in a sluggish response of the transducer 300 since the transducer 300 is too far from the surface to be measured 110.

In some embodiments, the at least one mechanical restraint 120 may be used to control the bondline thickness. For example, in embodiments where the mechanical restraint is a groove, the groove 120 may be used to control the volume of adhesive that is receivable in the groove 120. Controlling the volume of the adhesive receivable in the groove may control the position of the transducer 100 normal to the surface of the transducer structure 100. For example, the groove 120 may provide the desired thickness of the bondline such that when the transducer 300 is adhered to the transducer structure 100, the groove height allows the transducer 300 to be secured in place with a specified volume of adhesive between the transducer structure 100 and the transducer 300. In other words, excess adhesive may be squeezed out of the groove 120 such that the bondline thickness is within an acceptable tolerance of the ideal range.

The at least one mechanical restraint 120 may be used to limit the positioning of the transducer 300 on the transducer structure 100, as described previously. For example, when an adhesive is applied to the transducer structure 100 and the transducer 300 is applied to the adhesive, the adhesive may result in slippage, or accidental positional change, of the transducer 300 across the surface of the transducer structure 100. The mechanical restraint 120 (e.g., groove) may reduce or eliminate positional error caused by adhesive slip by preventing the transducer 300 from moving within the groove 120.

The one or more mechanical restraints 120 may prevent adhesive slip, or accidental positional change, of the transducer 300 across multiple surfaces on the transducer structure 100. For example, when the transducer 300 is bent from one surface to another, the at least one mechanical restraint 120 may limit the positioning of the transducer 300 such that adhesive slip is minimized across the plurality of surfaces.

It will be appreciated that the bondline thickness may vary depending on the desired use of the transducer structure 100. For example, in some embodiments, the adhesive may be about 10 microns thick. The bondline thickness may vary depending on, including, but not limited to, adhesive viscosity, surface roughness, and/or adhesive strength.

In some embodiments, the groove height may be constant across one or more surfaces of the transducer structure 100. For example, if the bondline thickness is desired to be a constant thickness value, the groove height may be constant.

In some embodiments, the groove height may be variable across one or more surfaces. For example, if a thicker bondline thickness is desired in one or more regions on the transducer structure 100, the groove thickness in that region may be increased. The groove height may be used to control the bondline thickness within, for example, a tolerance of about 10 microns to about 50 microns. The tolerance may vary depending on the use of the transducer structure 100. The groove height may be greater than a thickness of the transducer. An advantage of this design is that the groove may protect the transducer 300 from delamination or other damage.

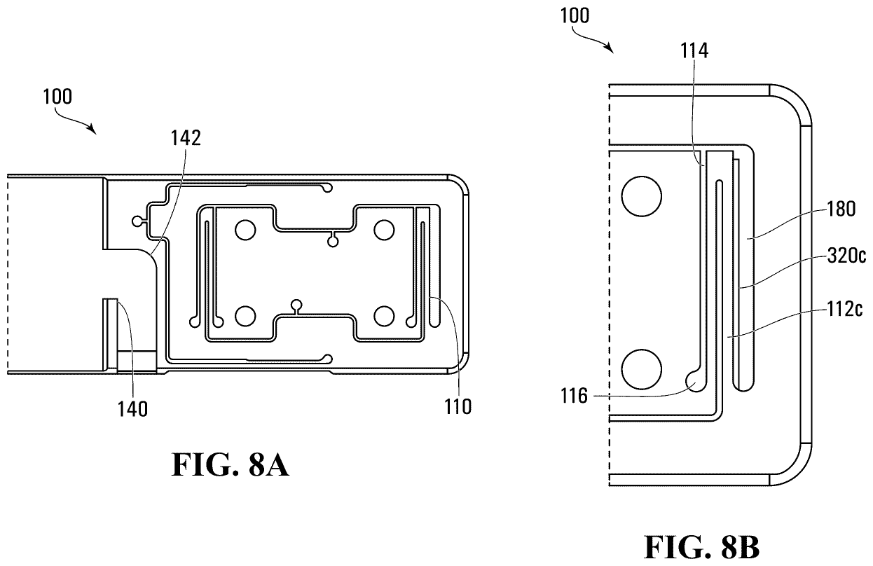

In some embodiments, the transducer structure 100 may include at least one channel 180 for controlling the displacement of adhesive when the transducer 300 is adhered to the transducer structure 100. As exemplified in FIGS. 1 and 8A-8B, the transducer structure 100 has a relief channel 180 proximate the front surface 174 of the transducer structure 100. The relief channel 180 is also proximate the kerf 114 that forms the elongate beam 112 proximate the front surface 174. The position of the relief channel 180 relative to the kerf 114 may control squeeze out of the adhesive when the transducer 300 is clamped to the transducer structure 100. In other words, when the transducer 300 is clamped onto the front surface 174, some adhesive may be squeezed out of the groove 120. If the adhesive were to spill into the kerf 114 that forms the elongate beam 112c, the elongate beam 112c would no longer operate as a thin beam since it would be adhered to the rest of the monolithic structure of the transducer structure 100. Accordingly, spilling adhesive into the kerf 114 from squeeze out may result in inaccurate measurements. For example, even a single drop of adhesive spilling into the kerf 114 may drastically impact the accuracy of the transducer measurements.

It will be appreciated that the at least one channel 180 may extend across one surface or may extend across a plurality of surfaces. In some embodiments, there may be a plurality of channels 180 on and/or in the transducer structure 100.

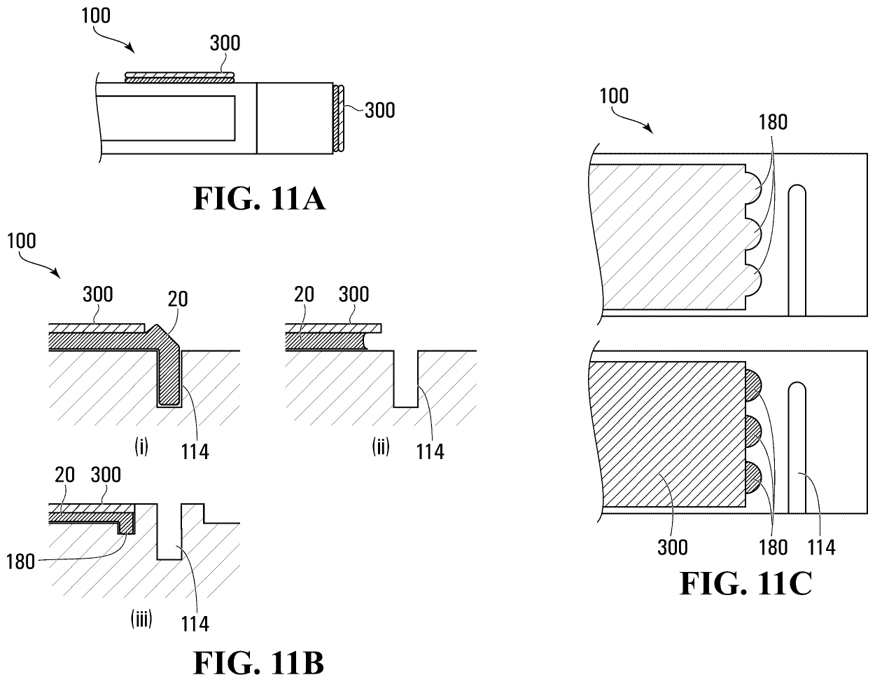

In some embodiments, the relief channel may extend entirely through the transducer structure 100, as exemplified in FIG. 1. One or more relief channels may not extend through the entire transducer structure 100 and may, alternately, or in addition, form pockets 182 for receiving excess adhesive, as exemplified in FIGS. 11A-11C. FIG. 11Bi shows a critical failure scenario when adhesive 20 enters a kerf 114. FIG. 11Bii shows a critical failure scenario when not enough adhesive is used to secure the transducer 300 to the transducer structure 100. FIG. 11Biii shows the use of a relief channel 180 that is a pocket for receiving excess adhesive 20. The one or more relief channels 180 may be any size and/or shape that facilitates containing excess adhesive 20. As exemplified in FIG. 11C, the channel 180 may be a series of pockets for receiving adhesive 20.

Accordingly, designing the transducer structure 100 to control the bondline thickness may provide one or more advantages, including, but not limited to: controlling the volume of adhesive used, controlling squeeze out during clamping, and/or preventing manufacturing defects by preventing adhesive from flowing to an undesired location on the transducer structure 100 that may be compromised by an excess of adhesive being present.

It will be appreciated that the adhesive may be any material that is capable of securing the transducer 300 to the transducer structure 100. For example, the adhesive may be, including, but not limited to, a semi-solid, a liquid, pressure sensitive adhesive, epoxy resin, cyanoacrylate, acrylic, polyurethane, silica, and/or combinations thereof. The adhesive may be a composite with a loading of, including, but not limited to, silica, glass, carbide, and/or combinations thereof. In some embodiments, the adhesive may be elastomerically toughened. The adhesive may form the adhesive bond by, including, but not limited to, light, moisture, and/or heat curing. In some embodiments, the adhesive may use both heat and two part cure epoxies and cyanoacrylate.

In some embodiments, a plurality of adhesives may be used on the transducer structure 300. The adhesive may vary across different zones or different components of the transducer structure 100. For example, a first adhesive may be used to secure the portions of the transducer 300 to the elongate beams 112 and a second adhesive may be used to secure the rest of the transducer 300 to the transducer structure. The first and second adhesives may be any adhesive or combination of adhesive. The use of different adhesive for different components of the transducer 300 may improve the speed and repeatability of the manufacturing process and may improve the manufacturing of more complicated and longer-form factor transducers 300.

### Temporary Mechanical Restraint

In some embodiments, the at least one mechanical restraint 120 may be temporarily positioned on the transducer structure 100. In other words, the at least one mechanical restraint 120 may be removable from the structure 100. For example, the at least one mechanical restraint 120 may be an elongated member that is received in a slot in the transducer structure 100. The elongated member may be used to at least partially limit the positioning of the transducer 300 on the transducer structure 100 and may pin at least a portion of the transducer 300 in at least two DoF when the transducer 300 is positioned on the transducer structure 100. Once the adhesive securing the transducer 300 to the transducer structure 100 has at least partially cured, the elongated member may be removed from the slot on the transducer structure 100.

As another example, the at least one mechanical restraint 120 may be a stencil that is positioned to contact the transducer structure 100 and may be held in place while the transducer 300 is adhered to the structure 100. The stencil may be used to limit the positioning of the transducer 300 on the transducer structure 100 and may operate to pin at least a portion of the transducer 300 in at least two DoF. Once the adhesive has cured or mostly cured, the stencil may be removed from the transducer structure 100. The stencil may also be used as a squeeze out control method.

In some embodiments, there may be a plurality of mechanical restraints 120 with at least one mechanical restraint 120 forming a permanent component of the structure 100 and at with at least one mechanical restraint 120 being removable from the structure 100.

### Progressive Registration Method

The method of securing the transducer 300 to the transducer structure 100 may occur as a form of progressive registration. In other words, a first portion of the transducer may be secured before securing the next portion of the transducer. In this way, the positioning of the transducer 300 on the transducer structure 100 may be optimized, as described previously, making use of one or more mechanical restraints 120 to pin portions of the transducer in place to ensure proper positioning before the rest of the transducer is secured.

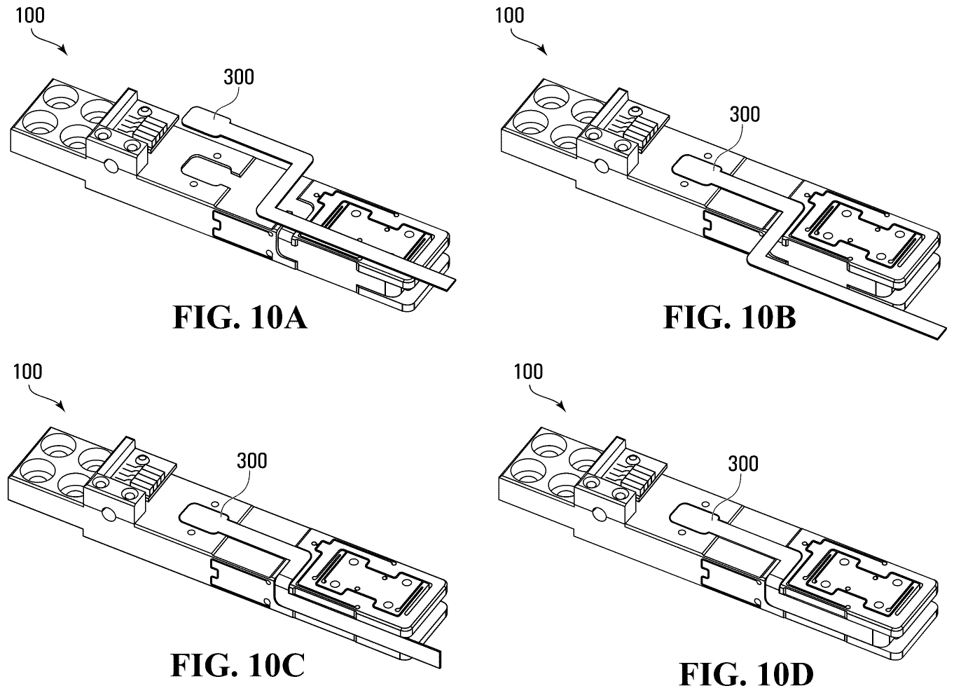

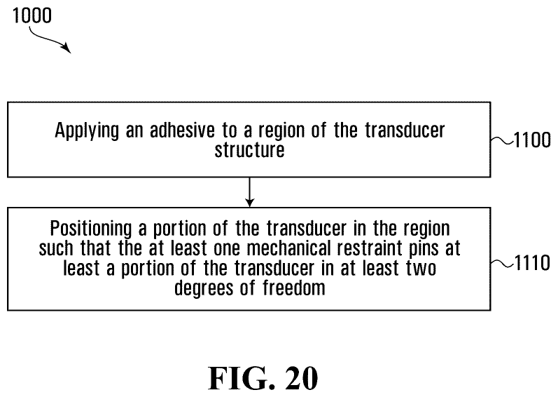

Referring to FIG. 20, shown therein is a flowchart of an exemplary method 1000 of adhering a transducer 300 to a transducer structure 100 having at least one mechanical restraint 120. At 1100, an adhesive is applied to a first region 190 of the transducer structure. At 1110 a portion of the transducer 300 is positioned in the first region 190 such that the at least one mechanical restraint 120 pins at least a portion of the transducer in at least two DoF, as exemplified in FIG. 10B.

Optionally, at 1200, the adhesive is applied to a second region 192 of the transducer structure 100. At 1210 a portion of the transducer 300 is positioned in the second region 192 such that the at least one mechanical restraint 120 pins at least a portion of the transducer from moving in at least two DoF, as exemplified in FIG. 10C.

Optionally, at 1300 the adhesive is applied to a third region 194 of the transducer structure 100. At 1310 a portion of the transducer 300 is positioned in the third region 194 such that the at least one mechanical restraint 120 pins at least a portion of the transducer from moving in at least two DoF, as exemplified in FIG. 10D.

It will be appreciated that the number of steps to the method 1000 will vary depending on the design of the transducer structure 100 and its complexity. The number of mechanical restraints 120 may vary. For example, there may be a different mechanical restraint 120 used for each of 1100, 1200, 1300. Alternately, a single mechanical restraint 120 may be used across multiple regions. The mechanical restraint 120 may be removable and the method 1000 may include removing the mechanical restraint 120 from the structure 100 once the adhesive has cured or mostly cured.

In some embodiments, the method 1000 may include applying a clamping force to one or more portions of the transducer 300 in one or more regions. The clamping force may be used to apply pressure to the transducer 300 while the adhesive cures on the transducer structure 100. This clamping force may vary with the adhesive material used. In some embodiments, a clamping force may not be required for the adhesive to cure properly. For example, less viscous adhesives such as epoxies may require less or no clamping force.

In some embodiments, the method 1000 may include using a plurality of adhesives. For example, a first adhesive, such as, e.g., epoxy, may be used to secure the transducer 300 to the transducer structure 100 across the elongated members 112 and a second adhesive, such as, e.g., a pressure sensitive adhesive, may be used for adhering the rest of the transducer 300 to the transducer structure 100. It will be appreciated the plurality of adhesives may be any adhesive or combination of adhesives. An advantage of this design is that the manufacturing process may be faster and more repeatable.

### Method of Manufacturing

The method of manufacturing the transducer structure 100 and securing the transducer 300 to the transducer structure 100 may vary depending on the design of the transducer structure 100. For example, in some embodiments, the transducer structure 100 may be machined to have one or more strain controller 114, otherwise referred to as kerfs 114. The kerfs 114 may be used to produce one or more elongate beams 112, as described previously. One or more mechanical restraints 120 may be machined into one or more surfaces on the transducer structure 100. Once the transducer structure 100 has been completely machined, the transducer 300 may be adhered to transducer structure 100, as described previously.

In this embodiment, care must be taken when clamping the transducer 300 to the transducer structure 100 to prevent damage to the surfaces to be measured 110. The surfaces to be measured 110 are often very thin and may be damaged by the clamping force used to secure the transducer 300 to the transducer structure 100. The damage may be exacerbated by heat when the clamping occurs at higher temperatures. The amount of damage caused by the clamping force may depend on the size and strength of the structure 100 and/or the elongate beams 112. For example, a smaller and/or thinner beam 112 may be more easily damaged by clamping than a larger and/or thicker beam 112. To prevent damage to the elongate beams 112, shims may be placed in the kerfs 114 to prevent warping and/or plastic deformation to the beams 112.

Sensors in the transducer 300 may be registered to the transducer 300. Accordingly, if positional errors are introduced into the position of the sensor relative to the surface to be measured 110, additional calibration may be needed to compensate for these errors.

In some embodiments, the transducer 300 may be secured to the transducer structure 100 before the kerfs 114 have been machined into the transducer structure 100. Once the transducer 300 has been secured to the transducer structure 100, the kerfs 114 may be machined into the structure 100, thereby forming one or more elongate beams 112. An advantage of this method is that the transducer 300 may be securely fastened to the transducer structure 100 before fragile components, such as the elongate beams 112, are machined into the structure 100. In other words, the transducer 300 may be, for example, clamped to the surface of the transducer structure 100 while minimizing or eliminating damage to the structure 100. Once the transducer 300 is securely fastened, the more fragile components, such as the elongate beams 112, may be machined into the transducer structure 100.

Once the transducer 300 has been secured to the transducer structure 100 and the surfaces to be measured 110 have been machined into the structure 100, the position of the transducer 300 may be registered using the actual position of the transducer 300. An advantage of this process is that the position of the transducer 300 may be registered more accurately.

In some embodiments, a conductive machining process may be used to machine the transducer structure 100. For example, as described previously, wire EDM may be used to form the kerfs 114. A conductive machining process cuts conductive materials while leaving non-conductive materials completely or mostly untouched. Accordingly, when the transducer 300 is secured to the transducer structure 100 prior to the kerfs 114 being machined, wire EDM may be used to cut the kerfs 114 while minimizing or eliminating damage to the transducer 300. The use of a conductive machining process on a conductive surface of the transducer structure 100 with a non-conductive transducer 300 may allow for very fine machining while avoiding damage to the transducer 300. The transducer 300 may be made of a material that can withstand autoclaving, thereby further reducing damage from machining.

In some embodiments, the transducer 300 may include at least a portion that is made of a conductive material. For example, the transducer 300 may include copper traces that can guide a conductive machining process. Accordingly, the conductive machining process used for machining the surfaces to be measured 110 may also be used to cut the transducer 300. The conductive component of the transducer 300 may be positioned in such a way to avoid damage to sensitive components of the transducer 300, such as the sensors.

In some embodiments, alignment marks may be used to improve the tolerance of the placement of the transducer 300 on the transducer structure 100. For example, in embodiments where the transducer 300 is applied to the transducer structure 100 prior to the machining of the surfaces to be measured 100, alignment marks on the transducer 300 may guide where the kerfs 114 should be machined such that the transducer 300 is registered to the proper location on the transducer structure 100.

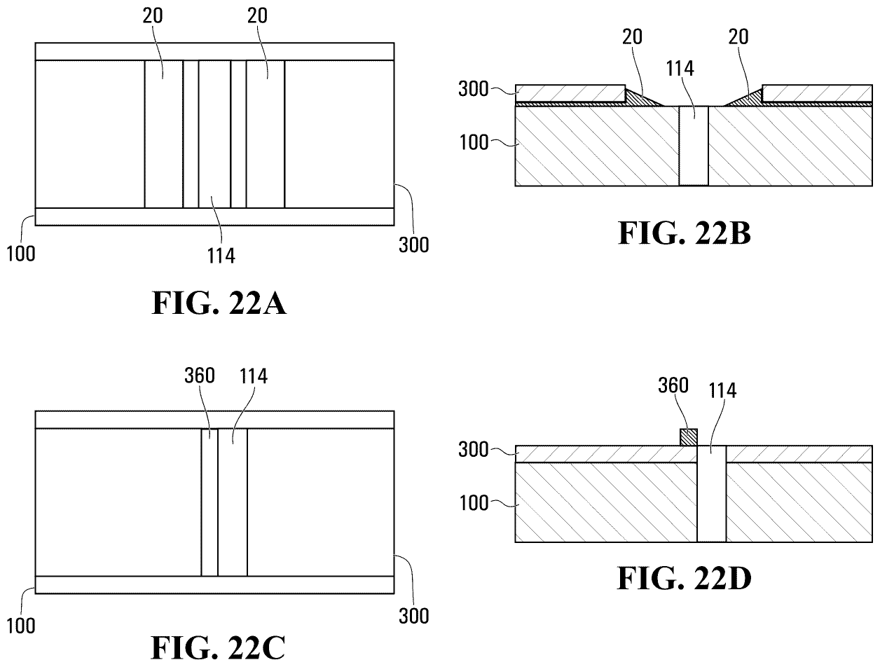

As described previously, when the kerfs 114 are machined prior to the securement of the transducer 300, care can be taken to avoid having adhesive contact the kerfs 114. As exemplified in FIGS. 22A and 22B, when the kerfs 114 are machined prior to the transducer 300 being positioned on the transducer structure 300, the edge of the transducer 300 may be positioned at a distance from the kerf 114. As shown, squeeze out from the adhesive 20 extends beyond the edge of the transducer 300. Accordingly, the space between the kerf 114 and the transducer 300 may be designed to reduce the likelihood of adhesive 20 entering the kerf 114. Even a single drop of adhesive in the kerf 114 may drastically impact the performance of the transducer 300. Alternately, the kerfs 114 may be machined after the transducer 300 has already been adhered to the transducer structure 100. Accordingly, by machining the kerfs 114 after the transducer 300 has been adhered to the transducer structure 100, the issue of squeeze out damaging the kerf 114 may be avoided.

In other words, when adhering the transducer 300 to the transducer structure 100, a clamping force may be applied to the portion of the transducer 300 on the transducer structure 100 to provide pressure to the adhesive 20. The clamping force may be applied until the adhesive 20 is cured. Once the adhesive 20 has cured, the strain controller 114 may be machined into the structure 100. It will be appreciated that the level of curing prior to the machining process may vary depending on the adhesive used.

When the transducer 300 is applied to the transducer structure 100 after the kerfs 114 have been machined, the relative position of the sensor on the transducer 300 to the surface to be measured 110 may be slightly offset, for example, due to positional errors described previously. Additionally, the pressure used to apply the transducer 300 to the structure 100 may damage sensitive components, such as the surfaces to be measured 110. Accordingly, by securing the transducer 300 to the transducer structure 100 before the kerfs 114 have been machined, and by using a conductive machining method, the kerfs 114 may be formed while minimizing or eliminating damage to the transducer structure 100, damage from clamping may be minimized or eliminated, the tolerance may be improved using, for example, alignment marks on the transducer 300, and/or calibration requirements may be further reduced and/or eliminated.

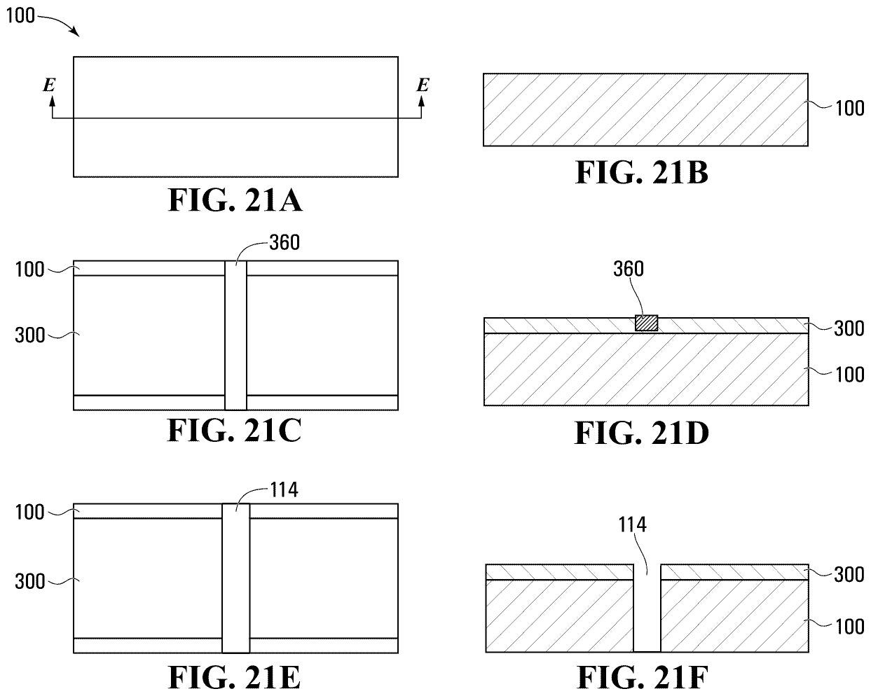

As exemplified in FIGS. 21A-21F, the transducer 300 has an alignment mark 360. The alignment mark 360 may be used to identify where the sensor is positioned within the transducer 300 and/or where the surface to be measured should be positioned in the structure 100, such that the kerf 114 may be machined in the desired location. In some embodiments, the transducer 300 may have a plurality of alignment marks 360. The alignment marks 360 may be used to provide a visual indicator of any type of machining or positioning process related to the transducer 300 and/or the transducer structure 100.

Once the transducer 300 is secured to the surface of the transducer structure 100 (FIGS. 21C and 21D), a machining method, such as wire EDM, may be used to cut through the alignment mark 360 (FIGS. 21E and 21F). By indicating the desired cut location of the kerf 114 relative to the transducer 300, positional error may be reduced. Another advantage of this design is that error may be repeatably reduced across a plurality of transducer structures 100.

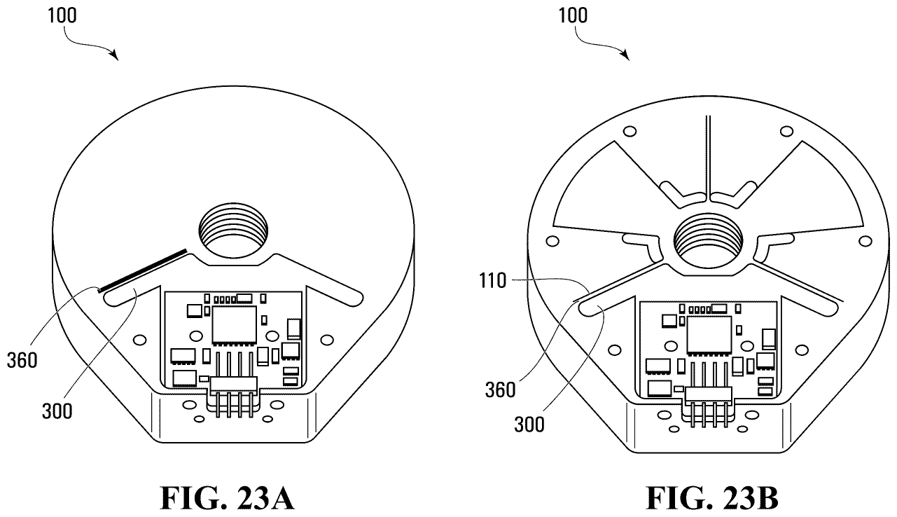

In some embodiments, the transducer 300 may have one or more additional portions that contain alignment marks 360. The additional portions may be used to overlap regions on the transducer structure 100 to provide a visual indicator on where to machine the structure 100. In other words, the transducer 300 may be designed to include portions that specifically guide the machining of the transducer structure 100. For example, as shown in FIG. 23A, the transducer 300 has an alignment mark 360 the overlaps a top portion of the transducer structure 100. The transducer 300 is positioned on the side portion of the structure 100, with an overlapping portion that extends to the top surface. As exemplified in FIG. 23B, the alignment mark 360 has been machined to form the surface to be measured 110.

It will be appreciated that the alignment mark 360 may be partially or fully cut during the machining process. For example, in some embodiments, the alignment mark 360 may indicate where the kerf 114 should be positioned and the kerf 114 may extend only partially along the length of the alignment mark 360.

In some embodiments, the alignment mark 360 may be used to provide a visual indicator of possible misalignment. As exemplified in FIGS. 22C and 22D, error was introduced during the machining of the kerf 114. This error is indicated by the misalignment of the alignment mark 360 to the kerf 114, whereby the alignment mark 360 has only been partially cut. The error may have been introduced by, for example, machining error, transducer manufacturing error, laser misalignment and/or photomask misalignment. This visual indication of misalignment may be used to assist a user in calibration, or may indicate that the structure 100 may need to be replaced.

While the above description describes features of example embodiments, it will be appreciated that some features and/or functions of the described embodiments are susceptible to modification without departing from the spirit and principles of operation of the described embodiments. For example, the various characteristics which are described by means of the represented embodiments or examples may be selectively combined with each other. Accordingly, what has been described above is intended to be illustrative of the claimed concept and non-limiting. It will be understood by persons skilled in the art that other variants and modifications may be made without departing from the scope of the invention as defined in the claims appended hereto. The scope of the claims should not be limited by the preferred embodiments and examples, but should be given the broadest interpretation consistent with the description as a whole.

1. A transducer structure comprising:
at least one mechanical restraint, the at least one mechanical restraint being shaped to receive a transducer such that the at least one mechanical restraint at least partially limits the positioning of the transducer on the transducer structure,
wherein the at least one mechanical restraint pins at least a portion of the transducer in at least two degrees of freedom when the transducer is positioned on the transducer structure.

2. The transducer structure of claim 1, wherein the at least one mechanical restraint pins the transducer in at least three degrees of freedom.

3. The transducer structure of claim 1, wherein the at least one mechanical restraint pins the transducer proximate a stress concentration zone of the transducer structure.

4. The transducer structure of claim 1, wherein the at least one mechanical restraint includes an elongated member.

5. The transducer structure of claim 1, wherein the transducer has a plurality of zones and the at least one mechanical restraint pins the transducer in the at least two degrees of freedom across the plurality of zones.

6. The transducer structure of claim 1, wherein the at least one mechanical restraint includes at least one corner that restrains the transducer in a cartesian plane and a rotational plane.

7. The transducer structure of claim 1, wherein the at least one mechanical restraint includes a groove having a plurality of walls extending from a base and the groove has a groove height extending from the base to a top of each wall in the plurality of walls.

8. The transducer structure of claim 7 wherein the groove height is greater than a thickness of the transducer.

9. The transducer structure of claim 8, wherein the groove height is variable.

10. The transducer structure of claim 1, wherein the at least one mechanical restraint is positioned on a first surface and the transducer extends parallel the first surface when positioned on the transducer structure.

11. The transducer structure of claim 10, wherein the at least one mechanical restraint pins the transducer in a plurality of degrees of freedom along the first surface when the transducer is positioned on the transducer structure.

12. The transducer structure of claim 1, wherein the at least one mechanical restraint includes a plurality of mechanical restraints, the transducer structure includes a plurality of surfaces, and wherein the plurality of mechanical restraints pins the transducer in the at least two degrees of freedom across each surface in the plurality of surfaces.

13. The transducer structure of claim 1, wherein the at least one mechanical restraint has at least one channel for controlling the displacement of adhesive when the transducer is adhered to the transducer structure.

14. The transducer structure of claim 13, wherein the at least one channel extends along a plurality of surfaces.

15. The transducer structure of claim 1, further comprising a strain controller for controlling the sensitivity of the transducer when the transducer is positioned on the transducer structure.

16. The transducer of claim 15, wherein the strain controller is at least one kerf in the transducer structure that forms an elongate member on which the transducer is positionable.

17. The transducer structure of claim 1, wherein the transducer structure is a monolithic structure.

18. The transducer structure of claim 1, wherein the at least one mechanical restraint is matingly shaped to receive the transducer such that the shape of the at least one mechanical restraint substantially limits the positioning of the transducer on the transducer structure.

19. The transducer structure of claim 1, wherein the at least one mechanical restraint surrounds at least a portion of a perimeter of the transducer when the transducer is positioned on the transducer structure.

20. The transducer structure of claim 1, wherein the transducer is flexible such that the transducer is conformable to a curved surface.

21. The transducer structure of claim 20, wherein the transducer is substantially incompressible and inextensible.

22. The transducer structure of claim 1, wherein the at least one mechanical restraint is removable.

23. A method of adhering a transducer to a transducer structure, the transducer structure having at least one mechanical restraint, the method comprising:
applying an adhesive to a region of the transducer structure; and
positioning a portion of the transducer in the region such that the at least one mechanical restraint pins at least a portion of the transducer in at least two degrees of freedom.

24. The method of claim 23, wherein the region is a first region and the portion is a first portion, the method further comprising:
applying the adhesive to a second region of the transducer structure; and
positioning a second portion of the transducer in the second region such that the at least one mechanical restraint pins at least a portion of the transducer from moving in at least two degrees of freedom.

25. The method of claim 24, further comprising:
applying the adhesive to a third region of the transducer structure; and
positioning a third portion of the transducer in the third region such that the at least one mechanical restraint pins at least a portion of the transducer in at least two degrees of freedom.

26. The method of claim 23, further comprising applying a clamping force to the portion of the transducer in the region.

27. The method of claim 23, wherein the at least one mechanical restraint comprises a plurality of mechanical restraints.

28. The method of claim 23, wherein the at least one mechanical restraint is removable and the method further comprises removing the at least one mechanical restraint from the transducer structure.

29. The method of claim 23, wherein the at least one mechanical restraint includes an elongated member.

30. The method of claim 23, further comprising:
applying a clamping force to the portion of the transducer in the region; and
machining at least one strain controller into the transducer structure.

31. The method of claim 30, wherein the clamping force is applied until the adhesive is at least partially cured and machining the at least one strain controller occurs after the adhesive has at least partially cured.
